(19) United States
(12) Patent Application Publication
(10) Pub. No.: US 2006/0271370 A1
(43) Pub. Date: Nov. 30, 2006

(54) MOBILE TWO-WAY SPOKEN LANGUAGE TRANSLATOR AND NOISE REDUCTION USING MULTI-DIRECTIONAL MICROPHONE ARRAYS

(76) Inventor: Qi P. Li, New Providence, NJ (US)

Correspondence Address: KAO H. LU, 686 LAWSON AVE, HAVERTOWN, PA, 19083, US

(21) Appl. No.: 11/419,501

(22) Filed: May 21, 2006

Related U.S. Application Data
(60) Provisional application No. 60/684,061, filed on May 24, 2005.

(51) Int. Cl. G10L 11/00

(52) U.S. Cl. 704/277

(57) ABSTRACT

A mobile two-way spoken language translation device utilizes a multi-directional microphone array component. The device is capable of translating one person's speech from one language into another language in either text or speech for another person and vice verse. Using this device, two or more persons who speak different languages can communicate with each other face-to-face in real time with improved speech recognition and translation robustness. The noise reduction and speech enhancement methods in this invention can also benefit other audio recording or communication devices.

### CROSS REFERENCE APPLICATIONS

This application claims priority from U.S. Provisional Patent Application No. USPTO 60/684061, filed on May 24, 2005.

### BACKGROUND OF THE INVENTION

### Field of the Invention

Interpreters are essential for languages translations when people communicate with each other using different languages; however, the cost to hire an interpreter is high and interpreters are not always available. Thus a mobile machine language translator is needed. Having a mobile machine language translator will be useful and economically effective in many circumstances, such as, a tourist visits a foreign place speaking different language or a business meeting between people speaking different languages. Although a two-way spoken language translator is used as the example to explain the design of the invention in this application, however, the same design principle can be used for any recording or communication device to achieve a good signal-to-noise ratio (SNR).

The current commercial available mobile language translation devices are one-way fixed-phrase translation where the device translates one's speech into another person's language, but not vice verse. Examples are the Phraselator® from Voxtec Inc. and Patent Application Number 03058606. One-way spoken language translation has limited the scope and capacity of the communication between speaker one and speaker two. Therefore, it is desirable to have a more effective device capable of translating simultaneously between two or more speakers using different languages.

### SUMMARY OF THE INVENTION

Facilitated by a multi-directional microphone array, the present invention is capable of translating one person's speech of one language into another language ether in the form of text or speech for another person, and vise versa. Referring to FIG. 1, the present invention includes one or two microphone arrays 102, 104 that capture the speech inputs from speaker one 100 and speaker two 108. A mobile computation device such as a PDA, that contains the acoustic beam forming and tracking algorithms 108, the signal pre-processing algorithms such as noise reduction/speech enhancement 110, an automatic speech recognition system that is capable of recognizing both speech from speaker one and speech from speaker two 112.

In addition, a language translation system that is capable of translating language one into language two and translating language two into language one 120, a speech synthesizer that is capable of synthesizing speeches from the text of language one and from the text of language two 118; one or two displaying devices 114, 124 that are capable of displaying relevant text on screen 220; and one or two loudspeakers 116, 122 that are capable of playing out the synthesized speeches. The present invention is superior to the prior art for the following reasons:
The present invention is designed for two-way full duplex communications between two speakers, which is much closer in style and manner to human face-to-face communication.
By using the microphone array signal processing techniques, one or more microphone arrays can be used to form two or more acoustic beams that focus on speaker one of language one and speaker two of language two. One microphone array can form multiple acoustic beams for multi-party communication scenario.
By using the beam forming algorithm, the sound in the beam focusing direction is enhanced while the sound from other directions is reduced.
By increasing the sampling rate, the geometric size of the microphone array can be smaller than lower sampling rate to have the same beam forming performance.
By using the noise reduction and speech enhancement algorithm, the signal-to-noise ratio of the recorded speech signal is improved.
By using adaptive beam forming techniques, once the beam focuses on a speaker, the acoustic beam can further track a free-moving speakers.
By using the microphone array and the noise reduction and the speech enhancement algorithms, the quality of recorded speech signal is improved in term of signal-to-noise ratio (SNR). This can benefit any audio recoding or communication device.
By using the microphone array and noise reduction and speech enhancement algorithms, the robustness of the speech recognizer is improved and the recognizer can provide better recognition accuracy in noisy environments.
By using the signal processing algorithm, the synthesized speech can sound like speaker one when translating for speaker one.

### BRIEF DESCRIPTION OF THE DRAWING

Other objects, features, and advantages of the present invention will become apparent from the following detailed description of the preferred but non-limiting embodiment. The description is made with reference to the accompanying drawings in which:

FIG. 1 is a diagram of the microphone array mobile two-way spoken language translator and its functional components;

FIG. 2 Where A is the physical front view of the mobile two-way spoken language translator; and B is the physical back view of the translator. The number and location of microphone components 200 can be changed according to application. All the microphone components comprise a microphone array which may form multiple beams. Or, the front and back microphone components comprise two microphone arrays, respectively;

FIG. 3 is an illustration of the acoustic beams forming that focuses on speaker A and B while excluding speaker C; thus, the voice from speakers A and B can be enhanced while the voice from speaker C and other directions can be suppressed;

FIG. 4 is an illustration of the acoustic beam tracking of speaker A and B when they move freely during talk;

FIG. 5(A) is a top view of an illustration that two acoustic beams 310, 320 can be formed from a single set of microphone array 330; or (B) from two sets of microphone arrays 340, 350;

FIG. 6 is the top views of: A an illustration of acoustic beams that formed in fixed patterns; B acoustic beams can be formed instantaneously to focus on current speaker; C acoustic beams can be formed to track particular speakers while they are moving; and D multiple acoustic beams can be formed to focus on multiple speakers or predefined directions;

FIG. 7 is the top view of linear and bi-directional microphone array configurations. A is the linear microphone array configuration. B-F are different types of bi-directional microphone array. All the microphone components may not in one plan of a 3-D space;

FIG. 8 illustrates one microphone array with two beam-forming units for sounds from different directions. Each unit has a separate set of filter or model parameters;

FIG. 9 illustrates a traditional beam-former implemented with FIR filters as a linear system with time-delay;

FIG. 10 illustrates a beam-former of the present invent implemented with a nonlinear time-delay network;

FIG. 11A is a front view of a four-sensor microphone array. FIG. 11B and C are the front and back views of another four-sensor microphone array. The solid line circle means that the microphone components are faced to front, while the dashed line means the microphone components are faced to back.

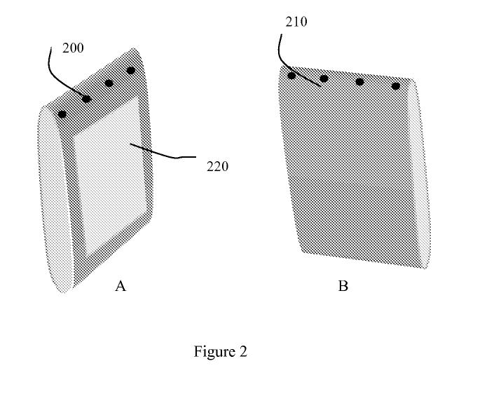

### DETAILED DESCRIPTION OF THE INVENTION

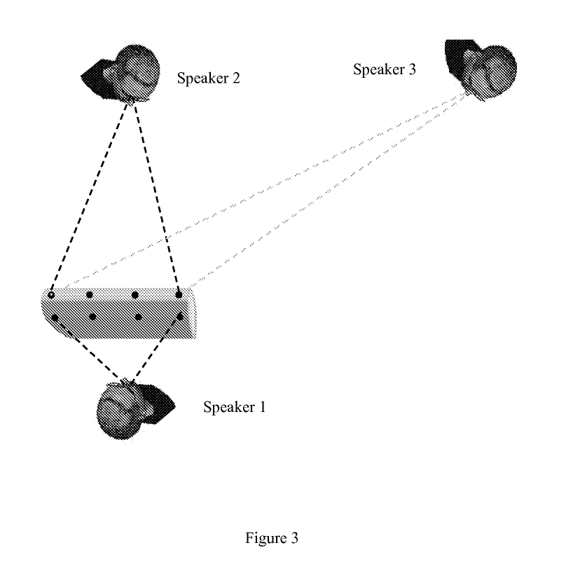

In one embodiment of the present invention, the microphone components can be placed in a 3-D space, and those components can form any 3-D shapes inside or outside an mobile computation device. Or, one microphone array can be mounted on the front side of a mobile computation device 200 while another microphone array can be mounted on the back of the computation device 210. A microphone array algorithm can be linear or non-linear. Two fixed patterns of beams computed by the algorithm, as shown in FIG. 6. A, are formed to focus on speaker one and two so that any speech from speaker three will be suppressed, as shown in FIG. 3. When speaker one 100 speaks language one, microphone array one 102 will capture the speech of language one. The signal pre-processor 110 will convert the speech of language one into digital signal and the noise of the digital signal is further suppressed before passed to the automatic speech recognizer 112. The speech recognizer will convert the speech of language one into text of language one.

Furthermore, the language translation system 120 will then convert the text of language one into text of language two which can be displayed on the screen 124 or fed the text into the speech synthesizer 118 to convert the text of language two into speech of language two. After speaker two receives the converted linguistic information from speaker one, speaker two could talk back to speaker one in language two. The microphone array number two will capture speaker two's speech through a fixed acoustic beam. Similarly, the signal pre-processor 110 will convert the speech of language two into digital signal whose noise will be further suppressed, then passed to the automatic speech recognizer 112. The speech recognizer will convert the speech of language two into text of language two. The language translation system 120 will then convert the text of language two into text of language one which can be displayed on the screen 114 or fed into the speech synthesizer 118 to convert the text of language one into speech number one. By this way, two persons speaking different languages can communication with each other face-to-face in real time.

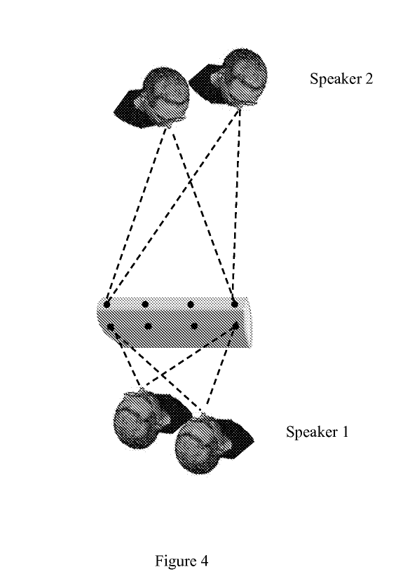

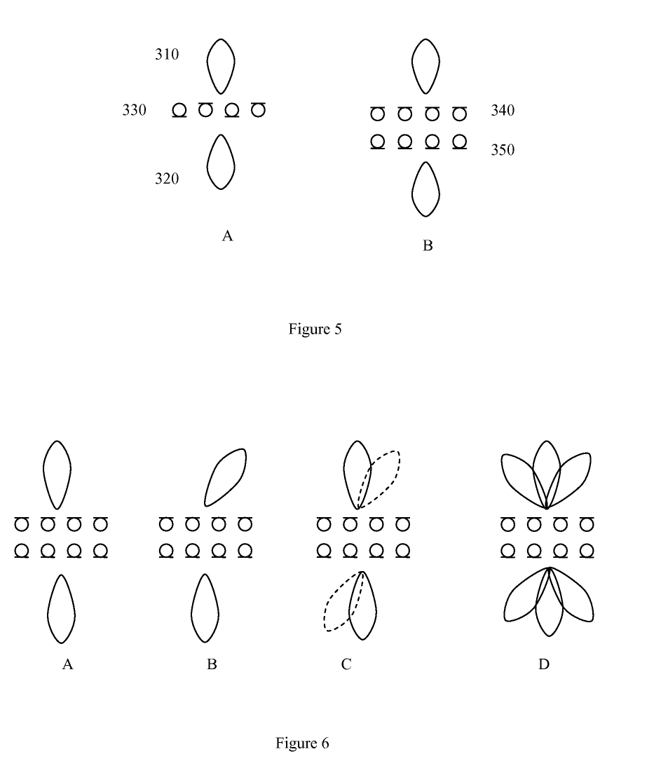

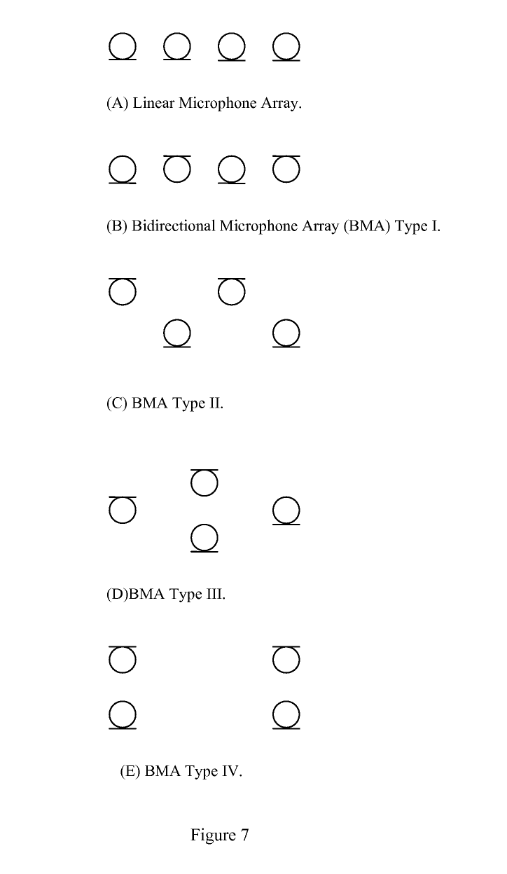

In another embodiment of the present invention when speaker one and/or speaker two move while talking, as shown in FIG. 4, the acoustic beams can be computed in real time to follow the speakers, as shown in FIG. 6(C). In this mode, speaker one and speaker two are not restricted to fixed positions relative to the mobile spoken language translator. In this way, the communication between two speakers are more flexible.

In yet another embodiment of the present invention when multiple parties are involved in the communication, acoustic beams can be configured to form in real time to focus on the current speaker, as in FIG. 6(B), or multiple acoustic beams can be formed in anticipation of multiple speakers, as in FIG. 6(D).

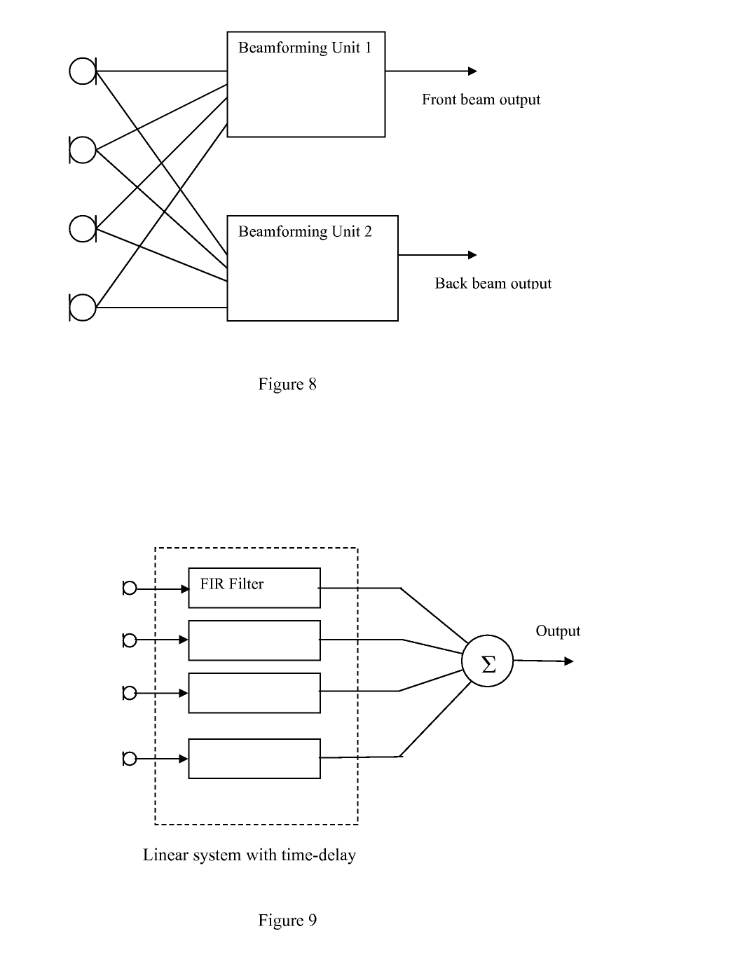

The bi-directional microphone array can be formed by two set of beam forming parameters, as shown in FIG. 8, while both sets share the same set of microphone array components. Similarly, multiple beams can be formed by multiple parameter sets but sharing one microphone array.

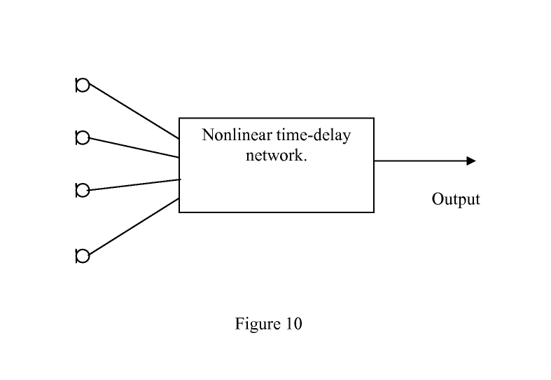

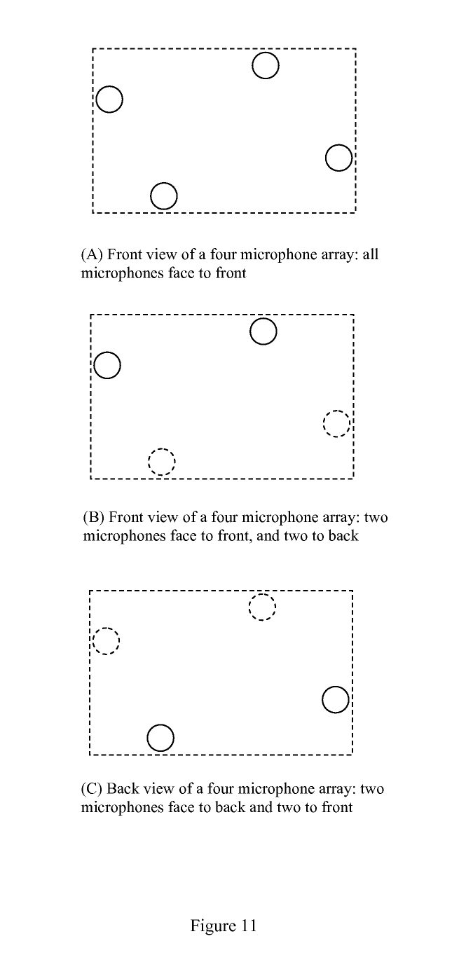

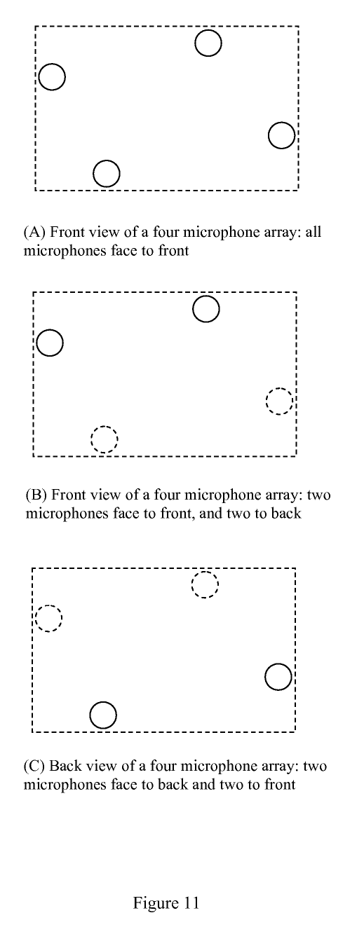

Traditionally, the sound direction is computed with a linear time-delay system, as in FIG. 9. The present invention includes a component to compute the sound direction using a nonlinear time-delay system as in FIG. 10, in which nonlinear functions are involved in the computation.

In order to reduce the geometric sized of a microphone array without reducing the beam forming performance, this invention increased the sampling rate during the beam forming computation. The sampling rate of the output of the microphone array can be reduced to the required rate. For example, a system need only 8 KHz sampling rate, but, in order to reduce the size of the microphone array, we increase the rate to 32 KHz, 44 KHz, or even higher. After the beam forming computation, we reduce the sampling rate to 8 KHz.

The invention also has the feature to have the speech generated from the text-to-speech synthesizer sound like the voice of the current speaker. For example, after speaker one talks in one language, the system translates speaker one's speech into another language, and then plays by a loudspeaker through a text-to-speech (TTS) system. The invention can have the sound of the translated speech like speaker one. This can be implemented by first estimating and saving speaker one's speech characteristics, such as speaker one's pitch and timbre, by a signal processing algorithm, and then use the saved pitch and timbre in the synthesized speech.

Alternatively, the present system can be implemented on any computation device including computers, personal computers, PDA, laptop personal computer or wireless telephone handsets. The communication mode can be face-to-face or remote through analog, digital, or IP-based network. There are many alternative ways that the invention can be used, including but not exclusive:

As a translator for any personnel spoken any language;

As a translator for any personnel in foreign countries;

As a translator for international tourists;

As a translator for international business conference and negotiation.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A mobile two-way spoken language translation device comprising:
One or more than one microphone arrays that capture speech inputs from a first speaker and a second speaker;
a mobile computation device comprising:
means for converting captured speech of a first language into corresponding digital signal;
means for converting the digital signal into corresponding text of the first language;
means for converting the text of the first language into the corresponding text of a second language; and
means for converting the converted text of the second language into speech in the second language;
a displaying device;
a loudspeaker; and
wherein said displaying device and said loudspeaker are embedded in said mobile computation device.

2. The device as claimed in claim 1, wherein some of the microphone components of the microphone array are distributed at the front side and/or the back side of the mobile computation device, such that two patterns of acoustic beams are formed to focus on said two speakers respectively, reducing sounds from other directions.

3. The device as claimed in claim 1, wherein one microphone array faces the front of said mobile computation device while other microphone array faces to the back of said mobile computation device, such that two patterns of beams are formed to focus on said two speakers respectively and to reduce sound from other directions.

4. The device as claimed in claim 1, wherein said microphone array is placed on a three-dimensional (3-D) spanning surface or frame structure. The surface constructed by the points of microphone components of the microphone array can be in any geometry shape, such as a sphere, half sphere, partial sphere, circle, etc., and is not necessary to be in a flat plane. The 3-D surface can be inside or outside the computation device, where the microphone array components can be connected to the computation device by wire or wireless communications.

5. The device as claimed in claim 1, wherein said mobile computation device comprises the software, firmware, and hardware to perform acoustic beam forming and adaptive beam tracking algorithms.

6. The beam forming and tracking algorithms as claimed in claim 5 can be a linear or nonlinear system with time-delay.

7. The device as claimed in claim 1, wherein said microphone array and computation device further comprises means for converting analog signal to corresponding digital signal, where the sampling rate can be higher than needed rate in order to reduce the geometric sized of the designed microphone array and the sampling rate can be reduced after the beam forming computation.

8. The device as claimed in claim 1, wherein said mobile computation device further comprises a noise reduction/speech enhancement unit.

9. The device as claimed in claim 1, wherein said mobile computation device further comprises an automatic speech recognizer that is capable of recognizing both speech and languages from said the first speaker and speech from said the second speaker.

10. The device as claimed in claim 1, wherein said mobile computation device further comprises a language translator that is capable of translating language one into language two and translating said language two into said language one.

11. The device as claimed in claim 1, wherein said mobile computation device further comprises a speech synthesizer that is capable of synthesizing speeches from the text of said language one and from the text of said language two.

12. The speech synthesizer as claimed in claim 11, wherein a pre-recorded speech can be used.

13. The speech synthesizer claimed in 11, wherein the synthesized speech voice can be adjusted to be similar to the first speaker's voice if the device is translating for the first speaker, or similar to the second speaker's voice if the device is translating for the second speaker by using signal processing algorithms.

14. The signal processing algorithms as claimed in 13, further having the capacity to estimate and save a human speaker's voice characteristics, such as pitch and timbre, and then use the saved voice characteristics to modify the synthesized speech voice of another language; thus the synthesized voice in another language sounds like the human speaker.

15. The device as claimed in claim 1, wherein said display device is capable of rendering said text on screen.

16. The device as claimed in claim 1, wherein said loudspeaker is capable of playing out the synthesized speeches.

17. The device as claimed in claim 1, wherein the device can be adapted with several pairs of language translation capability, i.e. translations any two languages or among several languages.

18. A method of mobile two-way spoken language translation comprising:
recording speech from speaker one of language one;
pre-processing the sound signal by utilizing analog-to-digital conversion;
forming an acoustic beam by using an array signal processing algorithm, tracking the source of the sound, and outputting one-channel speech signal;
further processing the one-channel speech signal for noise reduction and speech enhancement;
using an automatic speech recognition system to convert the speech into text format;
using a language translation system to translate the text of language one into text of language two;
using a speech synthesizer to synthesize the speech from the text of language two;
displaying the translated text on an screen;
playing the synthesized speeches through a loudspeakers;
symmetrically, recording speech from the second speaker of language two using the same or another microphone array and using the above process to translate language two to language one.

19. The method of claim 18, wherein said automatic speech recognition system is capable of recognizing both speech from the first speaker and speech from the second speaker.

20. The method of claim 18, wherein said language translation system is capable of translating language one into language two and translating language two into language one.

21. The method of claim 18, wherein said speech synthesizer is capable of synthesizing speeches from the text of language one and from the text of language two.

22. The method of claim 18, further reducing sounds which originate from outside the beam range.

23. The method of claim 18, further forming multiple acoustic beams in anticipation of multiple speakers when multiple speakers are involved in the communication.

24. A method for using a microphone array to improve the quality of recorded speech signals, in term of signal-to-noise ratio (SNR), comprising:
capturing speech inputs from at a microphone arrays;
a mobile computation device comprising:
converting the captured speech into the corresponding digital signal;
conducting array signal processing;
conducting noise reduction and speech enhancement; and
converting the digital signal into audible outputs.
